(19) United States
(12) Patent Application Publication
(10) Pub. No.: US 2012/0028845 A1
(43) Pub. Date: Feb. 2, 2012

(54) Sensor for Detecting Biological Agents in Fluid

(76) Inventors: Ross Teggatz, McKinney, TX (US); Scott Curry, Richardson, TX (US); Wayne Chen, Plano, TX (US)

(21) Appl. No.: 12/897,672

(22) Filed: Oct. 4, 2010

Related U.S. Application Data
(60) Provisional application No. 61/248,481, filed on Oct. 4, 2009.

(51) Int. Cl. C40B 60/12

(52) U.S. Cl. 506/39

(57) ABSTRACT

Systems and apparatus are disclosed for detecting biological agents in fluids. Biosensor apparatus utilizes a sample chamber configured for receiving a fluid sample. Wells accessible from the sample chamber include electrodes deployed for receiving one or more electromagnetic signal from each of the wells. The electrodes are pre-provided with biomaterial deposits selected to attract particular biological agents of interest. An integrated circuit connected with electrodes facilitates electromagnetic signal acquisition and processing of parameters measurable at the well electrodes.

### PRIORITY ENTITLEMENT

This application is entitled to priority based on Provisional Patent Application Ser. No. 61/248,481 filed on Oct. 4, 2009. This application and the Provisional patent application have at least one common inventor.

### TECHNICAL FIELD

The invention relates to apparatus and systems for detecting biological agents in fluids. More particularly, the invention relates to apparatus and systems for identifying biological agents in small samples of liquids such as blood, or other fluids.

### BACKGROUND OF THE INVENTION

Generally, prevention of disease transmission requires the rapid detection and identification of the causative agent. Human pathogens and similar biological agents most often spread through a population because of a lack of detection and awareness. With the increase in global travel, the problem of the spread of diseases from country to country has become an increasing concern. In order to minimize the spread of diseases, there is a demand for detection technology that facilitates the testing of individuals before arriving at their destinations in order to determine whether the individuals are carrying specific diseases. Also important is the ability to ensure a safe blood supply. Current enzyme, colorimetric, and fluorescence-based detection technologies require extensive infrastructure and highly-trained personnel to ensure their success. Moreover, these technologies are limited primarily by their restriction to the detection of a single biological agent. Detection and monitoring of health conditions such as anemia, sickle cell anemia, hemophilia, diabetes, and substance abuse, often utilizes the testing of blood or other fluid samples. In many testing scenarios, it is necessary and/or desirable to make use of a small sample of fluid. Existing blood analysis is commonly performed on a sample of blood drawn from the vein of the arm, the finger, or the earlobe. These samples are typically taken in large quantities, 2 to 3 vials at a time, with 1 vial containing approximately 5 ml of blood. Laboratory personnel then analyze the physical and chemical composition of the blood samples using hematological tests and procedures employing microscopes, automatic analyzers and/or biosensors. Breath analysis devices exist for chemical and/or medical analysis of exhaled air. Such samples typically have a low concentration of substances that may be targeted for testing.

Due to the foregoing and possibly additional problems, there is a need for improved apparatus and systems for rapidly detecting a wide range of liquid-borne biological agents, and conditions having indicia in fluids, without the burden of requiring large samples, specialized infrastructure, and highly-trained personnel. Such a need is particularly acute in developing countries that do not have the financial or laboratory capacity to support existing detection techniques on a large scale.

### SUMMARY OF THE INVENTION

In carrying out the principles of the present invention, in accordance with preferred embodiments, the invention provides advances in the arts with useful and novel apparatus and systems for biological agent detection. The invention provides significant biosensor miniaturization and circuit integration for the implementation of biological agent detector arrays adapted for detecting single or multiple biological agents from a single, relatively small, sample. According to preferred embodiments, the invention provides portable point-of-care apparatus and systems with a disposable biosensor array whose cost is significantly lower than existing testing technology. As used herein, the term biological agent is used to refer to pathogens and generally to any other organism or substance, especially microorganisms, capable of causing disease, including bacteria, viruses, protozoa or fungi. The embodiments described herein are intended to be exemplary and not exclusive. Variations in the practice of the invention are possible and preferred embodiments are illustrated and described for the purposes of clarifying the invention. All possible variations within the scope of the invention cannot, and need not, be shown.

According to one aspect of the invention, in an example of a preferred embodiment, apparatus for detecting biological agents includes a sample chamber configured for receiving a fluid sample with a filter through which the sample may be transmitted to a plurality of wells. The wells each include a plurality of electrodes configured for receiving one or more electromagnetic signal from within the well. A biomaterial deposit in each well is positioned in close proximity to the electrodes. An integrated circuit operably coupled to the electrodes is provided by which electromagnetic signals may be acquired from each well for processing.

According to additional aspects of the invention, preferred embodiments of sensor apparatus for detecting biological agents in fluid includes two or more deposits of dissimilar biomaterials.

According to another aspect of the invention, preferred embodiments of apparatus for detecting biological agents in fluid include electrodes containing one or more of, molybdenum, tungsten, niobium, tantalum, and rhenium.

According to another aspect of the invention, preferred embodiments of apparatus for detecting biological agents in fluid include electrodes containing one or more of the elements generally known as refractory metals.

According to yet another aspect of the invention, a preferred embodiment of apparatus for detecting biological agents in fluid includes electrodes containing an alloy of cobalt.

According to another aspect of the invention, a preferred embodiment of apparatus for detecting biological agents in fluid includes electrodes containing an alloy of chromium.

According to still another aspect of the invention, a preferred embodiment of a system of the invention includes biosensor apparatus and associated electronics for signal processing, analysis, and output.

The invention has advantages including but not limited to providing one or more of the following features: reduced biological agent detection times compared to standard laboratory tests; reduced sample size requirements; improved portability, enabling low-power, and/or battery-operated real-time testing in remote locations; simplified testing, reducing the need for highly specialized personnel; and reduced costs. These and other advantages, features, and benefits of the invention can be understood by one of ordinary skill in the arts upon careful consideration of the detailed description of representative embodiments of the invention in connection with the accompanying drawings.

### BRIEF DESCRIPTION OF THE DRAWINGS

The present invention will be more clearly understood from consideration of the description and drawings in which:

FIG. 1 is a partial cutaway perspective view of an example of a preferred embodiment of biosensor apparatus;

FIG. 2 is a partial cross section showing aspects of the apparatus of FIG. 1 in further detail;

FIG. 3 is a partial top view of the apparatus of FIG. 3; and

FIG. 4 is a block diagram illustrating preferred embodiments of biosensor apparatus and systems according to the invention.

References in the detailed description correspond to like references in the various drawings unless otherwise noted. Descriptive and directional terms used in the written description such as front, back, top, bottom, upper, side, et cetera; refer to the drawings themselves as laid out on the paper and not to physical limitations of the invention unless specifically noted. The drawings are not to scale, and some features of embodiments shown and discussed are simplified or amplified for illustrating principles and features as well as advantages of the invention.

### DESCRIPTION OF PREFERRED EMBODIMENTS

The exemplary portable point-of-care testing apparatus and system disclosed provides a combined biosensor device and related system incorporating a fluid sample chamber with microelectronic circuitry. In preferred embodiments, the apparatus and systems are configured for directly testing for multiple fluid-borne biological agents simultaneously. Generally, the system utilizes changes in electrical signals in a sample instigated by the interaction between biomaterial provided in the apparatus with biological agents present in the sample. Biological agents, broadly defined, also include fluid-borne indicia which may be associated with health conditions, such as iron deficiency, blood sugar level, and drug levels. As the term is used herein, a biosensor is a device that utilizes one or more deposits of biomaterials selective for fluid-borne biological agents combined with electrodes for detecting the ensuing reaction. The provided biomaterials provide the electrodes with their sensitivity to particular biological agents in a sample. Biomaterials such as antibodies, hormones, lipids, proteins and carbohydrates may be used. The associated microelectronic circuitry is adapted for detecting the extent of the interaction. Circuitry converts the detected electromagnetic parameters into one or more data signals that can be amplified, output, manipulated, and analyzed.

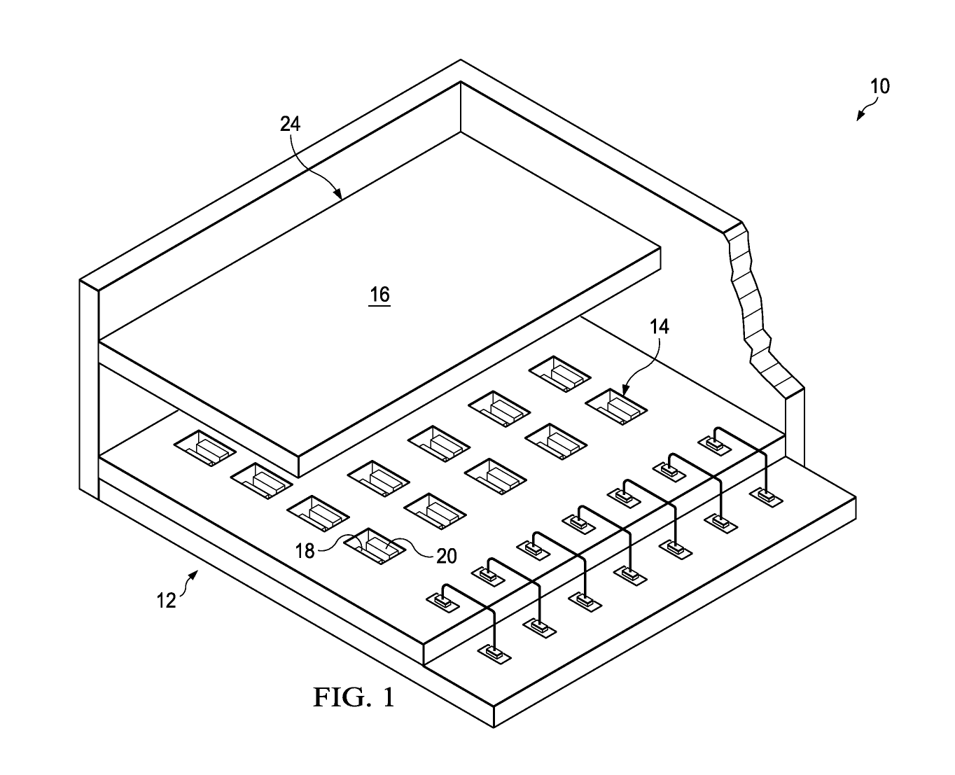

It has been determined that fluids having different protein concentrations can have corresponding measurable differences in electrical characteristics. Novel apparatus and systems have been developed for using this principal for detecting biological agents in fluids. Shown in the exemplary apparatus 10 of FIG. 1, an array 12 of individual wells 14 is situated adjacent to a sample chamber 16 configured for receiving a fluid sample, in this example liquid. Each individual well 14 is equipped with electrodes 18, 20 for measuring electrical characteristics within the well 14. An integrated circuit 22 connected with the well electrodes 18, 20 facilitates taking electrical data from the electrodes 18, 20. In operation, a liquid sample is placed in the sample chamber 16. Preferably, the sample chamber 16 includes a filter 24 through which the sample liquid is passed to the wells 14. The filter 24 may include one or more layers for preventing extraneous matter from reaching the wells 14. When sampling blood for example, it may be desirable to filter the sample such that the plasma portion of the blood is allowed to reach the wells 14 while larger particles are excluded. This reduces blockage and minimizes interference caused by the cells of the immune system that have antibodies on their surface. The wells 14 preferably contain deposits 26 of selected biomaterials, such as antigens selected for the detection of particular pathogens. The well electrodes may be positioned such that they come into direct contact with the sample fluid, or they may be covered to prevent corrosion. Preferably, some wells are provided with identical antigens in order to provide redundancy to ensure accurate testing. Multiple antigens may also be used, in individual wells, in wells deployed in a dispersed pattern, or arranged in well sub-arrays within the larger well array. For example, using multiple antigens in sub-arrays of wells, biosensor implementations of the invention may be used for a portable point-of-care blood testing system with the capability of identifying multiple blood-borne biological agents simultaneously.

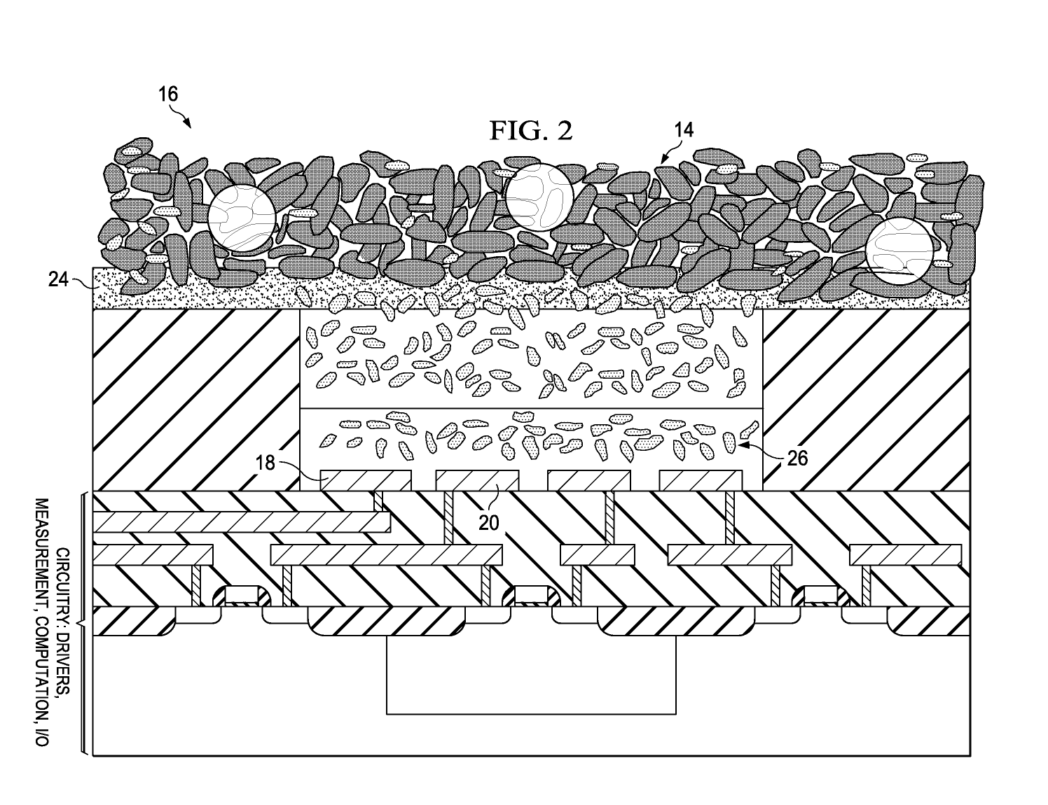

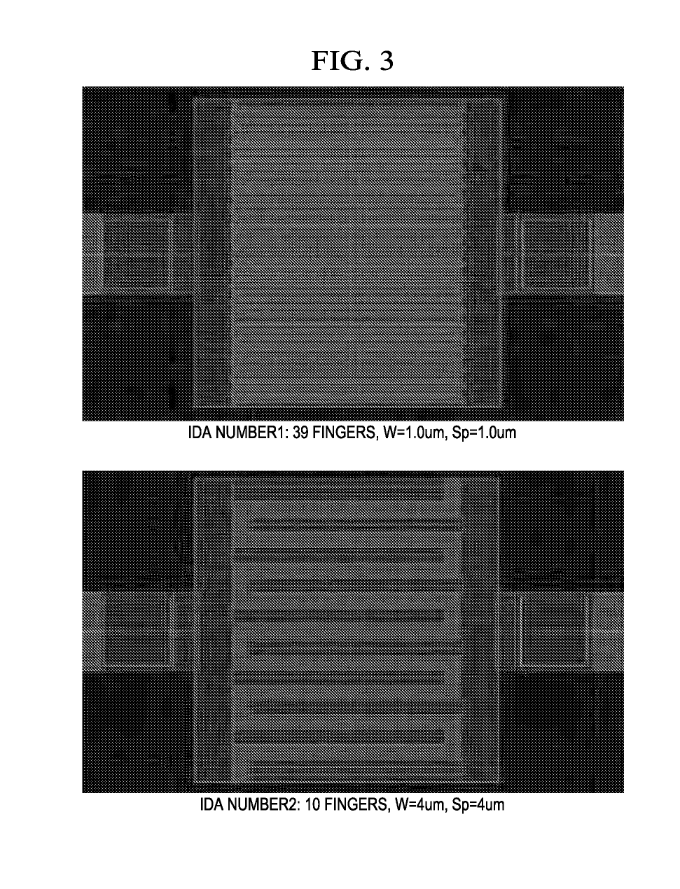

Now referring primarily to FIG. 2, a close-up partial cross-section of the apparatus 10 of FIG. 1 is shown in which the structure of an individual well 14 is depicted. Plasma from a blood sample placed in the sample chamber 16 is permitted access to the well 14 through a filter membrane 24. Within the well 14, a selected biomaterial 26, such as an antigen is deposited during the manufacturing process, located in close proximity to, or directly upon, one or more of the well electrodes 18, 20. The biomaterials 26 may be deposited on the bottom of the wells 14 and preferably subsequently lyophilized or cryodessicated for long term stability to facilitate storage and transport prior to use. The biomaterial 26 and electrodes 18, 20 are situated in close proximity to one another in a configuration in order that electromagnetic characteristics of the fluid subsequently placed within the well 14 can be picked up by the electrodes 18, 20. The well electrodes 18, 20 are preferably made from metals and/or alloys selected for their receptivity to electromagnetic signals and for their resistance to oxidation, fouling, and corrosion when exposed to air and other fluids such as blood, plasma, or urine. For example, titanium has been found to be a suitable metal, as well as gold, and platinum, all of which also have the advantage of being readily adaptable for use and compatibility with common IC manufacturing processes. Other corrosion-resistant metals such as the group of metals generally known as refractory metals, and alloys such as, for example, those containing rhenium, chromium, and/or cobalt may be used. Generally, combinations including silicon and refractory metals are suitable. Preferably, the well electrodes 18, 20 are arranged in parallel pairs in an interdigitated configuration throughout the well 14. For example, as shown in the top view of FIG. 3, the well electrodes 18, 20 may be provided with a width W of one micron and a spacing S of one micron. It is believed that width and spacing of about 1-5 microns are particularly suitable for many blood biosensor implementations. In general, a preferred approximate range of range for electrode width and spacing is about 0.5 um to 10 um, with overall electrode areas within the range of about 1000 to 40,000 square microns. It has been found that electrodes substantially rectangular in cross section are preferred, although a more-or-less circular cross section or other shapes may also be suitable. Various well electrode dimensions and geometries may be used for various detectors designed to test for specific biological agents or for use with specific fluids or liquids. It should also be understood that various well electrode dimensions and geometries may be used from individual cell to individual cell within the same well array.

As a general principle, the apparatus and systems described measure the presence of biological agents, most notably antibodies, specialized proteins in the blood capable of binding to other proteins or substances, which interact with specific pathogens. Antibodies are present in the blood as a result of the natural human immune response. The immune system constantly samples the environment inside the human body for foreign material. An early, and essential, response of the immune system to an infection is to produce antibodies. When a previously unknown pathogen is detected in the body, the immune system begins to make antibodies that can attach to it. These new antibodies induce and facilitate other elements of the immune system to clear the pathogen. Once exposed, the immune system maintains the production of these antibodies. Consequently, antibodies that recognize specific pathogens are only present in the blood of a person after exposure to the pathogen. Once an exposure has taken place, antibodies are an extremely sensitive indicator of an individual's exposure to an infective agent. This is the rationale for the tests for determining exposure; the presence of antibodies equates to exposure. The invention combines and uses biomaterials, electrodes, and microelectronic circuitry to exploit this relationship. The amount of antibody in the blood can also provide information as to whether the pathogen is an active infection or the result of a prior infection. Preferably, each well has specific biomaterials deposited within that represent unique biological agents of interest, with an additional identifier for their position in the array. If the test subject has been exposed to, or is currently infected by, a biological agent, the sample will have antibodies that bind to the biomaterials in the corresponding well(s). Upon binding, the relative concentration of the biological agent in that well increases. This increase is measured by the electrodes and underlying integrated circuit and circuit board interface associated with the well electrodes. When coupled a suitable portable reader, the results may be provided in real-time. It should be appreciated by those skilled in the arts that the electrodes may be used in several ways to influence the sample fluid. For example, the polarity may be reversed from that described immediately above. That is, in alternative embodiments a biological agent may be repelled from the electrodes and the corresponding electrical signals measured. Additionally, in some cases material may be added to the sample in order to enhance, or attenuate, a particular chemical and/or biological response, in turn enhancing or attenuating the electrical signal generated by the biological agent in the well. A high electric field across the electrodes, or a piezoelectric element, may be used to manipulate or agitate the sample fluid to enhance the reaction. The attracting or repelling of the sample fluid material by the electrodes, due to the polarity of the fluids or biological agents, may also be used to draw the sample fluid into the wells from the sample chamber, or into the sample chamber itself. Additionally, different potentials can be placed across the electrode to create electrophoresis.

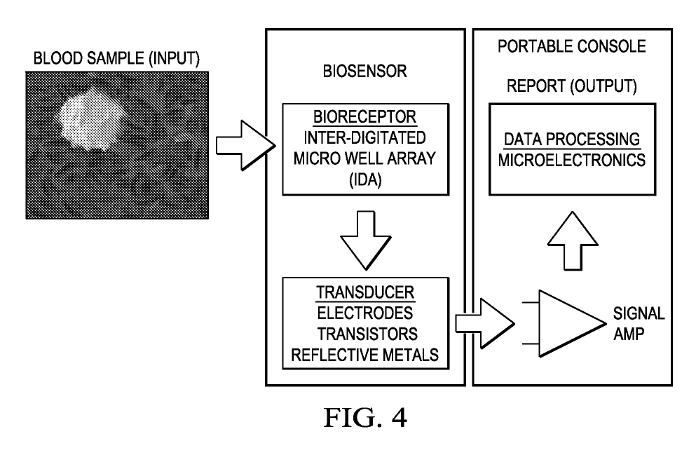

An example of the operation of a system for detecting biological agents in fluids is illustrated in FIG. 4. The well electrodes are electrically connected with integrated circuitry configured for acquiring the electrical signal(s) detected in the wells. Associated circuitry is also preferably provided for processing the signals, including functionality such as input/output control, measurement, computations, and amplification. As portrayed in the simplified schematic diagram, a fluid sample, such as a blood sample, is input into the sample chamber. A portion of the sample passes into each of the wells. A plurality of the wells have been previously prepared with deposited biomaterials such as antigens representing specific biological agents. One or more electromagnetic, electrostatic, electroresistive, or other signals related to the presence or absence of biological agents in the fluid sample are detected within the wells. The integrated circuitry receptive to such signals preferably transmits the signals to additional electronic circuitry such as an associated portable console or computer device having data processing, communications, and/or other output capabilities for making use of the data generated by the electromagnetic signal detection at the electrodes within the wells. It is preferred for the data processing and human interface aspects of the electronics to be provided in a reusable mobile handset biochip reader. The sample-handling portion of the biosensor is preferably disposable or recyclable. Preferably, signals with known magnitudes are applied across the electrodes at various frequencies and the resulting electrical characteristics within the wells are measured. Generally, biological agent concentrations may be observed across more than one test frequency within the range of about 10⁻¹² to 10¹² Hz. Various electrical characteristics may be used in identifying the presence of antibodies or other biological agents. Electromagnetic signals used for detection of biological agents may include magnetic, piezoelectric, potentiometric, resistive, inductive, capacitive, electrostatic, seebeck, or other parameters measurable by electrode pairs. Though impedance measurements are the presently preferred approach, the apparatus and systems may be adapted to use additional types of measurements to provide further discrimination among biological agents. Admittance measurements are also a useful parameter for determining differences in biological agent concentrations. Between protein concentrations for example, measured admittance levels may generally correlate to concentrations when titanium electrodes are used. In preferred embodiments, impedance magnitude and phase versus frequency plots, consisting of a real part versus an imaginary part may yield suitable results. However, other measurements such as a dissipation factor modeling and fitting to lumped circuit models may also be used for biological agent detection.

The close proximity of the circuitry to the well electrodes enhances the ability to achieve the required measurements. To illustrate the sensitivity potentially required of a biosensor system, the calculated quantity of target antibodies for each pathogen is only about 0.5-20 pg. Utilizing semiconductor electronics and nanotechnology, in the invention the effective concentration is increased by several orders of magnitude by the specific attraction of target biological agents to the well electrodes using immobilized biomaterials. The integration of electronics onto the biosensor chip itself provides a novel advantage in that a significant amount of circuitry onto the biosensor device increases efficiency at an acceptable cost. Many impairments that affect the electronics and physical system can be greatly reduced with minimizing the circuit size and ensuring close proximity to the well electrodes. A significant advantage is the reduction of undesired electrical effects caused by the physical structure of the implementation, typically known as parasitic effects such as stray capacitance. Electrical noise, another significant impairment, is also reduced through the integrated small scale realization of the measurement apparatus and system.

While the making and using of various exemplary embodiments of the invention are discussed herein, it should be appreciated that the apparatus and techniques for its use exemplify inventive concepts which can be embodied in a wide variety of specific contexts. It should be understood that the invention may be practiced in various applications and embodiments without altering the principles of the invention. For purposes of clarity, detailed descriptions of functions, components, and systems familiar to those skilled in the applicable arts are not included. In general, the invention provides apparatus and systems for biosensors combining IC and micro mechanical device technology making use electromagnetic signals detected in fluid samples by their reaction with biomaterials prepositioned within the biosensor. The invention is described in the context of representative exemplary embodiments. Although variations and alternatives for the details of the embodiments are possible, each has one or more advantages over the prior art.

The systems and methods of the invention provide one or more advantages including but not limited to one or more of, portability and ease of use. While the invention has been described with reference to certain illustrative embodiments, those described herein are not intended to be construed in a limiting sense. For example, variations or combinations of features or materials in the embodiments shown and described may be used in particular cases without departure from the invention. Although the presently preferred embodiments are described herein in terms of particular examples, modifications and combinations of the illustrative embodiments as well as other advantages and embodiments of the invention will be apparent to persons skilled in the arts upon reference to the drawings, description, and claims.

We claim:

1. Apparatus for detecting biological agents in fluid comprising:
a sample chamber configured for receiving a fluid sample;
a filter through which sample fluid may be received from the sample chamber and transmitted to a plurality of wells;
each individual well further comprising a plurality of electrodes configured for receiving one or more electromagnetic signal from the well;
each individual well further comprising a biomaterial deposit positioned in close proximity to the electrodes; and
an integrated circuit operably coupled to the electrodes whereby one or more electromagnetic signals may be acquired from each well for processing.

2. Apparatus for detecting biological agents in fluid according to claim 1 wherein a plurality of biomaterial deposits comprise a plurality of dissimilar biomaterials.

3. Apparatus for detecting biological agents in fluid according to claim 1 wherein a plurality of biomaterial deposits comprise antigens.

4. Apparatus for detecting biological agents in fluid according to claim 1 wherein a plurality of biomaterial deposits are positioned on the surfaces of a plurality of electrodes.

5. Apparatus for detecting biological agents in fluid according to claim 1 wherein the filter is configured to permit the passage of blood plasma from the sample chamber to the wells.

6. Apparatus for detecting biological agents in fluid according to claim 1 wherein the electrodes are arranged pairs in an interdigitated configuration.

7. Apparatus for detecting biological agents in fluid according to claim 1 wherein the electrodes and the integrated circuit are configured for acquiring one or more impedance measurement from one or more well.

8. Apparatus for detecting biological agents in fluid according to claim 1 wherein the electrodes and the integrated circuit are configured for acquiring one or more complex impedance measurement from one or more well.

9. Apparatus for detecting biological agents in fluid according to claim 1 wherein the electrodes and the integrated circuit are configured for acquiring one or more admittance measurement from one or more well.

10. Apparatus for detecting biological agents in fluid according to claim 1 wherein the electrodes and the integrated circuit are configured for acquiring one or more magnetic field measurement from one or more well.

11. Apparatus for detecting biological agents in fluid according to claim 1 wherein the electrodes and the integrated circuit are configured for acquiring one or more direct current conductance measurement from one or more well.

12. Apparatus for detecting biological agents in fluid according to claim 1 wherein the electrodes and the integrated circuit are configured for acquiring one or more alternating current conductance measurement from one or more well.

13. Apparatus for detecting biological agents in fluid according to claim 1 wherein the electrodes and the integrated circuit are configured for acquiring one or more phase measurement from one or more well.

14. Apparatus for detecting biological agents in fluid according to claim 1 wherein the electrodes and the integrated circuit are configured for acquiring one or more amplitude measurement from one or more well.

15. Apparatus for detecting biological agents in fluid according to claim 1 wherein one or more of the electrodes comprises a semiconductor material.

16. Apparatus for detecting biological agents in fluid according to claim 1 wherein one or more of the electrodes comprises a metal selected for its high resistance to corrosion.

17. Apparatus for detecting biological agents in fluid according to claim 1 wherein one or more of the electrodes comprises one or more of the metals selected from the group; molybdenum, tungsten, niobium, tantalum, rhenium.

18. Apparatus for detecting biological agents in fluid according to claim 1 wherein one or more of the electrodes comprises one or more of the elements selected from the group; titanium, vanadium, chromium, zirconium, hafnium, ruthenium, osmium and iridium.

19. Apparatus for detecting biological agents in fluid according to claim 1 wherein one or more of the electrodes comprises an alloy comprising cobalt.

20. Apparatus for detecting biological agents in fluid according to claim 1 wherein one or more of the electrodes comprises an alloy comprising chromium.

21. Apparatus for detecting biological agents in fluid according to claim 1 wherein one or more of the electrodes comprises one or more of gold, platinum.

22. Apparatus for detecting biological agents in fluid according to claim 1 wherein the electrodes are arranged in pairs in an interdigitated configuration, wherein spacing between each electrode in a pair is from about 0.1 micron to about 100 microns.

23. Apparatus for detecting biological agents in fluid according to claim 1 wherein the electrodes are approximately rectangular in cross section.

24. A system for detecting biological agents in fluid comprising:
biosensor apparatus further comprising;
a sample chamber configured for receiving a fluid sample;
a plurality of wells, each having electrodes configured for receiving one or more electromagnetic signal from the well, the electrodes each having a biomaterial deposit;
an integrated circuit operably coupled to the electrodes whereby one or more electromagnetic signal may be acquired from each well for processing.

25. The system for detecting biological agents in fluid according to claim 21 further comprising a portable device configured for communication with the integrated circuit for providing data processing functionality.

26. The system for detecting biological agents in fluid according to claim 21 further comprising a portable device configured for communication with the integrated circuit for providing communications functionality.
